(19) United States
(12) Patent Application Publication
(10) Pub. No.: US 2024/0281239 A1
(43) Pub. Date: Aug. 22, 2024

(54) IN-VEHICLE CONTROL DEVICE

(71) Applicant: TOYOTA JIDOSHA KABUSHIKI KAISHA, Toyota-shi (JP)

(72) Inventor: Ryuki Hirono, Nagoya-shi (JP)

(73) Assignee: TOYOTA JIDOSHA KABUSHIKI KAISHA, Toyota-shi (JP)

(21) Appl. No.: 18/438,826

(22) Filed: Feb. 12, 2024

(30) Foreign Application Priority Data
Feb. 21, 2023 (JP) 2023-025070

(51) Int. Cl. G06F 8/65; B60R 16/023

(52) U.S. Cl. CPC G06F 8/65; B60R 16/0231

(57) ABSTRACT

A control signal selection unit receives a first control signal for controlling a target in-vehicle device from a first processor of a first ECU, and receives a second control signal for controlling the target in-vehicle device from a second processor of a second ECU. When the control signal selection unit receives both the first control signal and the second control signal within the predetermined time, the control signal selection unit does not send the first control signal to the target in-vehicle device, but sends the second control signal to the target in-vehicle device.

### CROSS-REFERENCE TO RELATED APPLICATION

This application claims priority to Japanese Patent Application No. 2023-025070 filed on Feb. 21, 2023, incorporated herein by reference in its entirety.

### BACKGROUND

### 1. Technical Field

This specification discloses an improvement in an in-vehicle control device.

### 2. Description of Related Art

Japanese Unexamined Patent Application Publication No. 2011-152022 (JP 2011-152022 A) discloses a power management device. When there is a plurality of power management devices that manages an electronic device, a power management device serving as a master device collects control signals for controlling the electronic device from a plurality of slave devices, selects the most received type of control signal from the collected control signals, and sends the selected control signal to the electronic device.

### SUMMARY

Conventionally, vehicles are equipped with an electronic control unit (ECU) for controlling an in-vehicle device. Specifically, the ECU includes a processor, and the processor sends control signals to the in-vehicle device to control the in-vehicle device.

It is herein assumed that a vehicle is equipped with a plurality of ECUs for controlling the same in-vehicle device. In particular, it is herein assumed that a vehicle is equipped with a first ECU and a second ECU. The first ECU is unable to communicate with an update server for updating software that is executed by a processor in an ECU, and the second ECU is able to communicate with the update server and is able to automatically update its software. In this specification, “software that is executed by the processor in the ECU” is referred to as “software of the ECU” etc. for convenience.

A vehicle may be equipped with the second ECU depending on the destination of the vehicle, user selection (optional function selected by the user), etc. For example, vehicles intended for use in an area with no update server or vehicles intended for use in an area where software updates by an update server are prohibited by law etc. are not equipped with the second ECU. Alternatively, when the processor of the second ECU is configured to perform a control related to an optional function that can be added by a user but the user does not add this optional function to a vehicle, this vehicle is not equipped with the second ECU. There are cases where the first ECU is attached to a vehicle in a non-detachable manner. When the second ECU is mounted on such a vehicle, it means that the vehicle is equipped with both the first ECU and the second ECU.

Therefore, there may be both vehicles equipped with only the first ECU and vehicles equipped with the first ECU and the second ECU.

When there may be both vehicles equipped with only the first ECU and vehicles equipped with the first ECU and the second ECU, the developer of software of the first ECU may have to prepare not only software of the first ECU for the vehicles equipped with only the first ECU, but also software of the first ECU for the vehicles equipped with the first ECU and the second ECU (e.g., software taking controlling of an in-vehicle device by the second ECU into consideration). This is disadvantageous in that development of a plurality of pieces of software requires cost, time, and effort, and may also create the need to manage the plurality of pieces of software.

An object of an in-vehicle control device disclosed in the present specification is to make it possible to use a single piece of software of a first ECU for both vehicles equipped with only a first ECU that is unable to communicate with an update server and vehicles equipped with the first ECU and a second ECU that is able to communicate with the update server.

An in-vehicle control device disclosed in this specification is characterized by including:
a first ECU including a first processor configured to control a target in-vehicle device mounted on a vehicle, the first ECU being unable to communicate with an update server configured to update software that is executed by a processor included in an ECU;
a second ECU including a second processor configured to control the target in-vehicle device, the second ECU being able to communicate with the update server; and
a control signal selection unit configured to send a first control signal and a second control signal, both for controlling the target in-vehicle device, to the target in-vehicle device, the first control signal being a signal received from the first processor and the second control signal being a signal received from the second processor, and the control signal selection unit being configured to, when the control signal selection unit receives both the first control signal and the second control signal within a predetermined time, not send the first control signal to the target in-vehicle device but send the second control signal to the target in-vehicle device.

According to this configuration, the first processor need only send the first control signal to the control signal selection unit regardless of whether there is the second ECU. When the vehicle is not equipped with the second ECU, the target in-vehicle device is controlled by the first control signal. On the other hand, when the vehicle is equipped with the second ECU and the control signal selection unit receives both the first control signal and the second control signal within the predetermined time, the second control signal rather than the first control signal is sent to the target in-vehicle device. Therefore, the target in-vehicle device can be controlled based on the software of the second ECU updated by the update server. That is, according to this configuration, there is no need to change the software of the first ECU depending on whether there is the second ECU, and it is possible to use a single piece of software of the first ECU for both vehicles equipped with only the first ECU and vehicles equipped with the first ECU and the second ECU. Specifically, according to this configuration, when the vehicle is equipped with only the first ECU, the target in-vehicle device can be controlled based on the first control signal from the first processor. When the vehicle is equipped with the first ECU and the second ECU, the target in-vehicle device can be controlled based on the second control signal from the second processor.

The first control signal and the second control signal may be signals for controlling power consumption of the target in-vehicle device according to power consumption of another in-vehicle device mounted on the vehicle.

According to this configuration, when power consumption of another in-vehicle device changes, power consumption of the target in-vehicle device can be controlled based on the changed power consumption.

The control signal selection unit may be located in the first ECU.

According to this configuration, the control signal selection unit can be operated by the software of the first ECU without preparing software for operating the control signal selection unit separately from the software of the first ECU. This can reduce the number of types of software to be managed.

According to the in-vehicle control device disclosed in the present specification, it is possible to use a single piece of software of the first ECU for both vehicles equipped with only the first ECU that is unable to communicate with the update server and vehicles equipped with the first ECU and the second ECU that is able to communicate with the update server.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of an in-vehicle control device according to the present embodiment; and

FIG. 2 is a flowchart showing the flow of processing of the in-vehicle control device according to this embodiment.

### DETAILED DESCRIPTION OF EMBODIMENTS

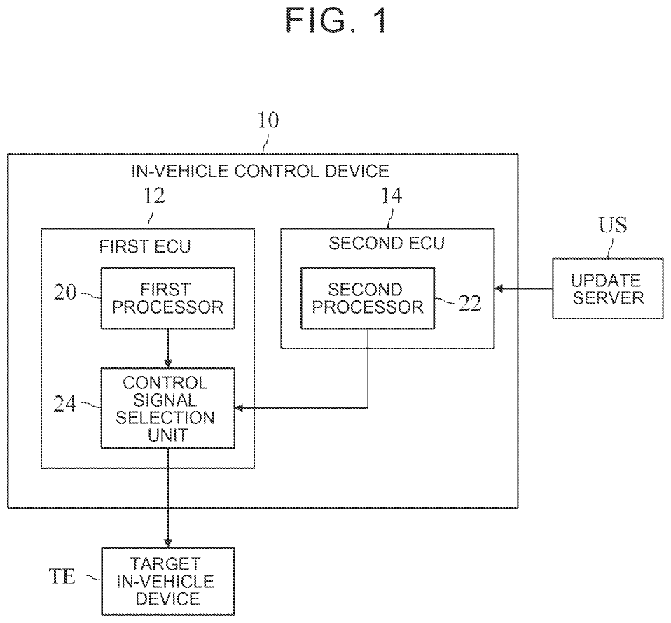

FIG. 1 is a schematic configuration diagram of an in-vehicle control device 10 according to this embodiment. The in-vehicle control device 10 and the target in-vehicle device TE that is an in-vehicle device to be controlled by the in-vehicle control device 10 are provided in the vehicle. The target in-vehicle device TE is, but is not limited to, a device that is located inside a vehicle cabin and that operates by consuming power. The target in-vehicle device TE is, for example, an audio device, an air conditioner, a seat heater, or a power seat.

The in-vehicle control device 10 includes a first ECU 12 and a second ECU 14. An ECU is a group of electronic circuits composed of a processor, memory, and their peripheral circuits. FIG. 1 shows a first processor 20 of the first ECU 12 and a second processor 22 of the second ECU 14.

The first processor 20 and the second processor 22 are each configured by a Central Processing Unit (CPU), an Application Specific Integrated Circuit (ASIC), a Field-Programmable Gate Array (FPGA), or a Complex Programmable Logic Device (CPLD). The first processor 20 and the second processor 22 may each be configured not by a single processor but by cooperation of a plurality of physically separated processors.

Both the first processor 20 and the second processor 22 control the same target in-vehicle device TE. Specifically, the first processor 20 and the second processor 22 control the target in-vehicle device TE in accordance with an instruction from a vehicle occupant or the state of the vehicle. For example, when the target in-vehicle device TE is an air conditioner, the first processor 20 and the second processor 22 control the target in-vehicle device TE according to a user's instruction to turn on the power, a user's instruction to change the temperature or air volume, or the temperature in the vehicle cabin.

In this embodiment, the first processor 20 and the second processor 22 control the power consumption of the target in-vehicle device TE according to the power consumption of other in-vehicle devices of the vehicle. For example, when other in-vehicle devices consume a large amount of power (for example, when an audio device or a seat heater that consumes a large amount of power is operating), the first processor 20 and the second processor 22 control the power consumption of the target in-vehicle device TE. Control the operation of the target in-vehicle device TE so as to suppress power consumption. The first processor 20 and the second processor 22 can acquire power consumption of other in-vehicle devices by power consumption sensors mounted on other in-vehicle devices or by acquiring information indicating the operation states of the other in-vehicle devices from these in-vehicle devices.

The method for controlling the target in-vehicle device TE by the first processor 20 and the second processor 22 will be described in detail later together with the control signal selection unit 24.

The first ECU 12 is an ECU that is unable to communicate with an update server US for updating the software of the ECU. In other words, the first ECU 12 is not placed in an environment in which the update server US can automatically update the software. Therefore, the first processor 20 controls the target in-vehicle device TE by executing software already written in the memory within the first ECU 12 when the vehicle is manufactured. The first ECU 12 is an ECU that is always installed in the vehicle in which the target in-vehicle device TE is installed.

The second ECU 14 is an ECU that is able to communicate with the update server US. In other words, the second ECU 14 is placed in an environment in which software can be automatically updated by the update server US. The software stored in the memory within the second ECU 14 is updated to the latest software by the update server US. Therefore, the second processor 22 controls the target in-vehicle device TE by executing the software updated (for example, the latest) by the update server US. The second ECU 14 is not necessarily provided in the vehicle. As mentioned above, the second ECU 14 is provided in the vehicle depending on the destination of the vehicle, the functions selected as options by the user, or the like.

In this embodiment, the first ECU 12 has a control signal selection unit 24. The control signal selection unit 24 is also configured by a processor such as a CPU, ASIC, FPGA, or CPLD.

The control signal selection unit 24 receives from the first processor 20 a first control signal for controlling the target in-vehicle device TE. Further, when the second ECU 14 is provided, the control signal selection unit 24 receives from the second processor 22 a second control signal for controlling the target in-vehicle device TE. Then, the control signal selection unit 24 sends the received first control signal or second control signal to the target in-vehicle device TE. Thereby, the target in-vehicle device TE is controlled.

As described above, in this embodiment, the first processor 20 and the second processor 22 control the power consumption of the target in-vehicle device TE according to the power consumption of other in-vehicle devices provided in the vehicle. Therefore, it can be said that the first control signal and the second control signal are signals for controlling the power consumption of the target in-vehicle device TE according to the power consumption of other in-vehicle devices provided in the vehicle.

When the control signal selection unit 24 receives both the first control signal and the second control signal within the predetermined time, the control signal selection unit 24 does not send the first control signal to the target in-vehicle device TE but sends the second control signal to the target in-vehicle device TE. That is, the control signal selection unit 24 gives priority to the second control signal over the first control signal and sends the second control signal to the target in-vehicle device TE.

As described above, the first processor 20 and the second processor 22 output the first control signal or the second control signal to the control signal selection unit 24 according to an instruction from the occupant, the state of the vehicle, etc. Therefore, when the second ECU 14 is provided, the first processor 20 and the second processor 22 often output the first control signal and the second control signal according to similar (same type) instructions at similar timing. On this premise, the reason why the second control signal is given priority over the first control signal is that, in many cases, the software of the second ECU 14 that is updated by the update server US is newer than the software of the first ECU 12 that is not updated by the update server US, and therefore the second control signal is more suitable for the current state of the vehicle than the first control signal.

For example, consider a case where the power consumption of other in-vehicle devices changes (increases or decreases) due to the addition of a new function to the other in-vehicle devices provided in the vehicle. It is herein assumed that after the power consumption of the other in-vehicle devices changes, the software of the second ECU 14 is updated by the update server US, and the second processor 22 can control the power consumption of the target in-vehicle device TE based on the changed power consumption of the other in-vehicle devices.

In this case, the software of the first ECU 12 does not take into account a change in power consumption of the other in-vehicle devices. Therefore, the first processor 20 still outputs the first control signal for controlling the power consumption of the target in-vehicle device TE to the control signal selection unit 24, based on the power consumption of the other in-vehicle devices before the change. On the other hand, the second processor 22 outputs a second control signal for controlling the power consumption of the target in-vehicle device TE to the control signal selection unit 24 based on the changed power consumption of the other in-vehicle devices. In such a case, since the second control signal is more suitable than the first control signal, the control signal selection unit 24 does not send the first control signal to the target in-vehicle device TE but sends the second control signal to the target in-vehicle device TE. Therefore, the target in-vehicle device TE is controlled by the second control signal that is based on the changed power consumption of the other in-vehicle devices. As a result, the power consumption is controlled more appropriately than at least when the power consumption is controlled by the first control signal.

For example, when the control signal selection unit 24 receives only the first control signal and does not receive the second control signal within a predetermined time, such as when the second ECU 14 is not provided, the control signal selection unit 24 sends the first control signal to the target in-vehicle device TE. When the control signal selection unit 24 receives only the second control signal and does not receive the first control signal within the predetermined time, the control signal selection unit 24 sends the second control signal to the target in-vehicle device TE.

The predetermined time is set to approximately several milliseconds to several tens of milliseconds. The predetermined time may be determined as appropriate by the designer of the in-vehicle control device 10 etc.

In this embodiment, the control signal selection unit 24 is provided in the first ECU 12. However, the control signal selection unit 24 may be provided in a device other than the first ECU 12 as long as it is always provided in the vehicle equipped with the target in-vehicle device TE. For example, the in-vehicle control device 10 may have a third ECU in addition to the first ECU 12 and the second ECU 14, and the control signal selection unit 24 may be provided in the third ECU. However, in this case, it is suitable to provide the control signal selection unit 24 in the first ECU 12 because it is necessary to manage the software of the third ECU separately from the software of the first ECU 12. In other words, by including the control signal selection unit 24 in the first ECU 12, the control signal selection unit 24 can be operated by the software of the first ECU 12, so the types of software to be managed can be reduced.

The outline of the in-vehicle control device 10 according to this embodiment is as described above. According to the in-vehicle control device 10, the first processor 20 can send the first control signal to the control signal selection unit 24 regardless of whether the second ECU 14 is present. When the vehicle is not equipped with the second ECU 14, the target in-vehicle device TE is controlled by the first control signal. On the other hand, when the vehicle is equipped with the second ECU 14 and the control signal selection unit 24 receives both the first control signal and the second control signal within the predetermined time, the control signal selection unit 24 sends the second control signal to the target in-vehicle device TE instead of the first control signal. Therefore, the target in-vehicle device TE can be controlled based on the software updated by the update server US (that is, the software of the second ECU 14). That is, according to this embodiment, there is no need to change the software of the first ECU 12 depending on whether the second ECU 14 is present. When the vehicle is equipped with only the first ECU 12, a single piece of software of the first ECU 12 can control the target in-vehicle device TE based on the first control signal from the first processor 20, and when the vehicle is equipped with the first ECU 12 and the second ECU 14, the single piece of software of the first ECU 12 can control the target in-vehicle device TE based on the second control signal from the second processor 22.

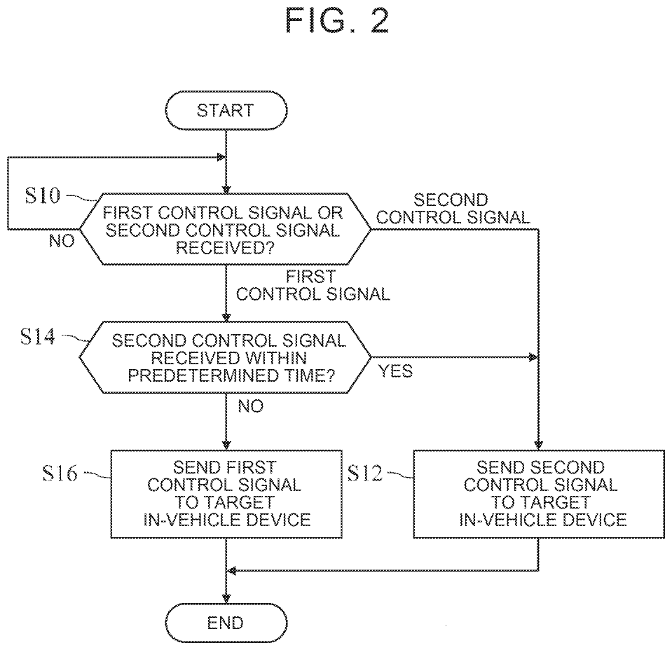

Hereinafter, the processing flow of the in-vehicle control device 10 (especially the control signal selection unit 24) according to the present embodiment will be described according to the flowchart shown in FIG. 2.

In S10, the control signal selection unit 24 determines whether either the first control signal from the first processor 20 or the second control signal from the second processor 22 is received.

When the second control signal is received, the process proceeds to S12, and in S12, the control signal selection unit 24 sends the received second control signal to the target in-vehicle device TE.

When the first control signal is received, the process proceeds to S14, and in S14, the control signal selection unit 24 determines whether the second control signal is received within a predetermined time after reception of the first control signal.

When the second control signal is received within the predetermined time after reception of the first control signal, the process proceeds to S12, and in S12, the control signal selection unit 24 sends the received second control signal to the target in-vehicle device TE. When the second control signal is not received within the predetermined time after reception of the first control signal, the process proceeds to S16, and in S16, the control signal selection unit 24 sends the received first control signal to the target in-vehicle device TE.

Although the embodiment of the in-vehicle control device according to the present disclosure is described above, the in-vehicle control device according to the present disclosure is not limited to the above embodiment, and various modifications can be made without departing from the spirit and scope of the present disclosure.

What is claimed is:

1. An in-vehicle control device, comprising:
a first electronic control unit including a first processor configured to control a target in-vehicle device mounted on a vehicle, the first electronic control unit being unable to communicate with an update server configured to update software that is executed by a processor included in an electronic control unit;
a second electronic control unit including a second processor configured to control the target in-vehicle device, the second electronic control unit being able to communicate with the update server; and
a control signal selection unit configured to send a first control signal and a second control signal, both for controlling the target in-vehicle device, to the target in-vehicle device, the first control signal being a signal received from the first processor and the second control signal being a signal received from the second processor, and the control signal selection unit being configured to, when the control signal selection unit receives both the first control signal and the second control signal within a predetermined time, not send the first control signal to the target in-vehicle device but send the second control signal to the target in-vehicle device.

2. The in-vehicle control device according to claim 1, wherein the first control signal and the second control signal are signals for controlling power consumption of the target in-vehicle device according to power consumption of another in-vehicle device mounted on the vehicle.

3. The in-vehicle control device according to claim 1, wherein the control signal selection unit is located in the first electronic control unit.
